(19) United States
(12) Patent Application Publication
(10) Pub. No.: US 2017/0061803 A1
(43) Pub. Date: Mar. 2, 2017

(54) CONTROLLER TERMINAL AND METHOD OF CONTROLLING WIRELESS AIRCRAFT

(71) Applicant: OPTiM CORPORATION, Saga (JP)

(72) Inventor: Shunji SUGAYA, Tokyo (JP)

(21) Appl. No.: 15/162,700

(22) Filed: May 24, 2016

(30) Foreign Application Priority Data
Aug. 28, 2015 (JP) 2015-169849

(51) Int. Cl. G08G 5/00; B64C 39/02; G05D 1/00; H04B 7/185

(52) U.S. Cl. CPC G08G 5/003; H04B 7/18506; B64C 39/024; G08G 5/0043; G05D 1/0044; G05D 1/0027; G05D 1/0038; B64C 2201/127; B64C 2201/146; B64C 2201/141

(57) ABSTRACT

A wireless aircraft is used to determine the flight route and the altitude by specifying an imaging area too large to be imaged in a single shot on the map. A controller terminal 100 communicating with a wireless aircraft 200 taking an image with a camera is used to store imaging area data on an imaging area specified from a user; and determines the flight route and the altitude of the wireless aircraft 200 to image the imaging area with a camera based on the stored imaging area data.

### CROSS REFERENCE TO RELATED APPLICATIONS

This application claims priority to Japanese Patent Application No. 2015-169849 filed on Aug. 28, 2015, the entire contents of which are incorporated by reference herein.

### TECHNICAL FIELD

The present invention relates to a controller terminal and a method of controlling a wireless aircraft that receive an imaging area specified from the user through the controller terminal communicated with a wireless aircraft that takes an image with a camera and determine the flight route and the altitude of the wireless aircraft to image the area.

### BACKGROUND ART

In the past, actual air planes such as a Cessna® plane and a helicopter have taken an air photograph of estate properties such as a building, a parking lot, and a land for sale in lots and scenic sites as tourist resources. However, taking air photographs from actual air planes has disadvantage due to the legally regulated altitude and flight time and the cost. Instead, uninhabited airborne vehicles such as radio control helicopter equipped with a camera have taken air photographs from the sky.

Recently, uninhabited airborne vehicles that are called drones have become common, which have enabled uninhabited airborne vehicles to more easily take air photographs from the sky. Although drones indicates all the uninhabited airborne vehicles, many are of multirotor types with a plurality of wings as their main characteristics, which can stably control the direction and the altitude of the airframe, which can be controlled by a communication method such as radio, Wi-Fi®, and Bluetooth®, which can install high performance camera to take high-quality images, and which can fly for a relatively long time.

As a technology to utilize an uninhabited airborne vehicle, the system which previously stores the flight route of the drone and images a house, a building, etc., from various angles from the sky at low cost to respond requests from clients has been proposed (Patent Document 1).

### CITATION LIST

### Patent Literature

Patent Document 1: JP 2005-269413 A

### SUMMARY OF INVENTION

However, in the method of Patent Document 1, the flight route is determined by humans. Therefore, the method of Patent Document 1 is difficult because the flight route including circling and hovering, the imaging procedures including pan, tilt, and zoom, etc., have to be manually determined.

Moreover, the method of Patent Document 1 is used for imaging objects such as houses and buildings. Therefore, this method cannot be respond to a request from the user who desires to image an area too large to be imaged in a single shot.

In view of the above-mentioned problems, an objective of the present invention is to provide a controller terminal and a method of controlling a wireless aircraft that determine the flight route and the altitude of the wireless aircraft by specifying a large imaging area on the map.

The first aspect of the present invention provides a controller terminal communicating with a wireless aircraft taking an image with a camera, including:

an imaging area data storing unit that stores imaging area data on an imaging area specified from a user; and

a flight route determining unit that determines the flight route and the altitude of the wireless aircraft to image the imaging area with a camera based on the stored imaging area data.

According to the first aspect of the present invention, a controller terminal communicates with a wireless aircraft taking an image with a camera; stores imaging area data on an imaging area specified from a user; and determines the flight route and the altitude of the wireless aircraft to image the imaging area with a camera based on the stored imaging area data.

The second aspect of the present invention provides the controller terminal according to the first aspect of the present invention, in which the flight route determining unit that, if the imaging area based on the imaging area data is taken with a plurality of wireless aircrafts, determines the altitude and the flight route of each of the wireless aircrafts.

According to the second aspect of the present invention, the controller terminal according to the first aspect of the present invention, if the imaging area based on the imaging area data is taken with a plurality of wireless aircrafts, determines the altitude and the flight route of each wireless aircraft.

The third aspect of the present invention provides the controller terminal according to the second aspect of the present invention further including an image data receiving unit that receives image data taken by the flight route from the wireless aircraft, in which the image data receiving unit, if receiving image data on a still image taken from a plurality of wireless aircrafts, superimposes the received image data on a predetermined image data based on the longitude and the latitude associated with the received image data.

According to the third aspect of the present invention, the controller terminal according to the second aspect of the present invention receives image data taken by the flight route from the wireless aircraft, and if receiving image data on a still image taken from a plurality of wireless aircrafts, superimposes the received image data on a predetermined image data based on the longitude and the latitude associated with the received image data.

According to the present invention, a controller terminal communicating with a wireless aircraft taking an image with a camera can determine the flight route and the altitude of the wireless aircraft by specifying an imaging area too large to be imaged in a single shot on the map.

### BRIEF DESCRIPTION OF DRAWINGS

FIG. 1 shows a schematic diagram of the controller terminal 100 and the wireless aircraft 200 according to a preferable embodiment of the present invention.

FIG. 2 shows a functional block diagram of the controller terminal 100 and the wireless aircraft 200 to illustrate the relationship among the functions.

FIG. 3 shows a flow chart of the controller terminal 100. FIG. 4 shows one example of the screen of the controller terminal 100 displaying a map.

FIG. 5 shows one example of the screen to specify an imaging area.

FIG. 6 shows one example of the screen to specify the start point.

FIG. 7 shows one example of the screen to specify the goal point.

FIG. 8 shows one example of the screen outputting the flight route and the altitude.

FIG. 9 shows one example of the data format of the flight route and the altitude that are determined by the flight route determining unit.

FIG. 10 shows a functional block diagram of the controller terminal 100 and the wireless aircraft 200 to illustrate the relationship among the functions when image data is synthesized.

FIG. 11 shows a flow chart of the controller terminal 100 and the wireless aircraft 200 when image data is synthesized.

FIG. 12 shows one example of the screen to specify the number of the wireless aircrafts 200.

FIG. 13 shows one example of the screen displaying the estimated required time after the number of the wireless aircrafts 200 is specified.

FIG. 14 shows one example of the screen to specify the start point of the first wireless aircraft 200.

FIG. 15 shows one example of the screen to specify the goal point of the first wireless aircraft 200.

FIG. 16 shows one example of the screen to specify the start point of the second wireless aircraft 200.

FIG. 17 shows one example of the screen to specify the goal point of the second wireless aircraft 200.

FIG. 18 shows one example of the screen outputting the flight route and the altitude of the first wireless aircraft 200.

FIG. 19 shows one example of the screen outputting the flight route and the altitude of the second wireless aircraft 200.

FIG. 20 shows one example of the data format of the flight route and the altitude of a plurality of wireless aircrafts 200 that are determined by the flight route determining unit.

FIG. 21 shows a flow chart of the flight route determining module 151.

FIG. 22 shows one example of the segmented imaging area taken at an altitude of 40 m.

FIG. 23 shows one example of the segmented imaging area taken at an altitude of 100 m.

### Description of Embodiments

Embodiments of the present invention will be described below with reference to the attached drawings. However, this is illustrative only, and the technological scope of the present invention is not limited thereto.

### Overview of Controller Terminal 100 and Wireless Aircraft 200

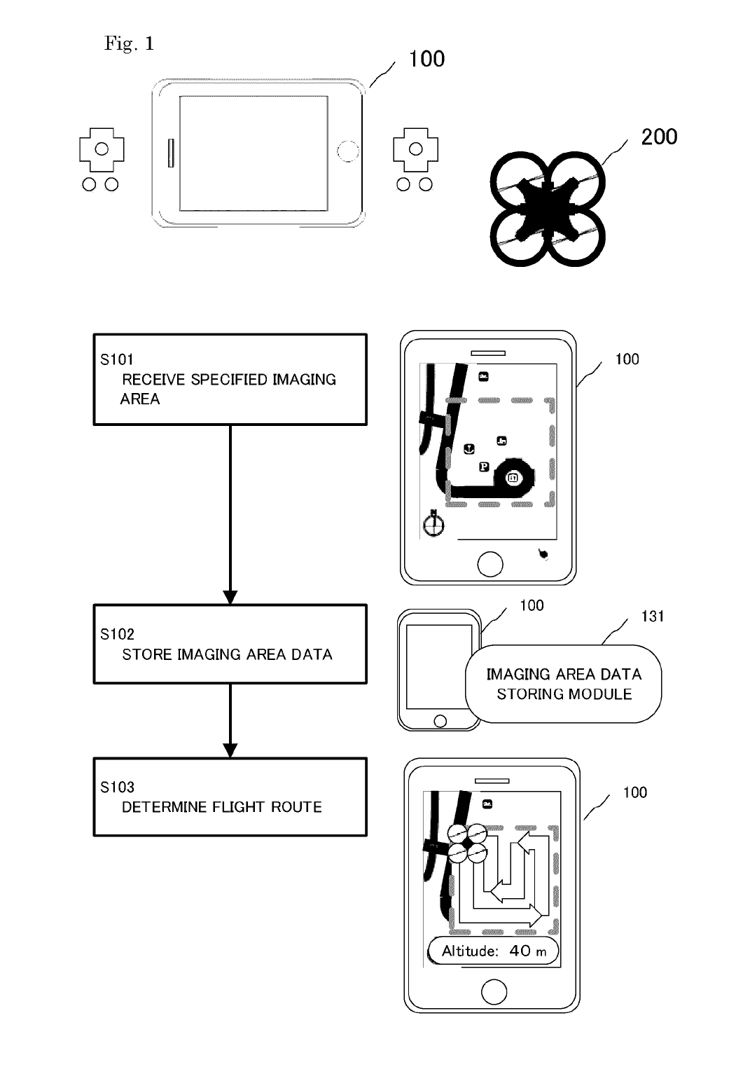

FIG. 1 shows a schematic diagram of the controller terminal 100 and the wireless aircraft 200 according to a preferable embodiment of the present invention. The overview of the present invention will be described below with reference to FIG. 1.

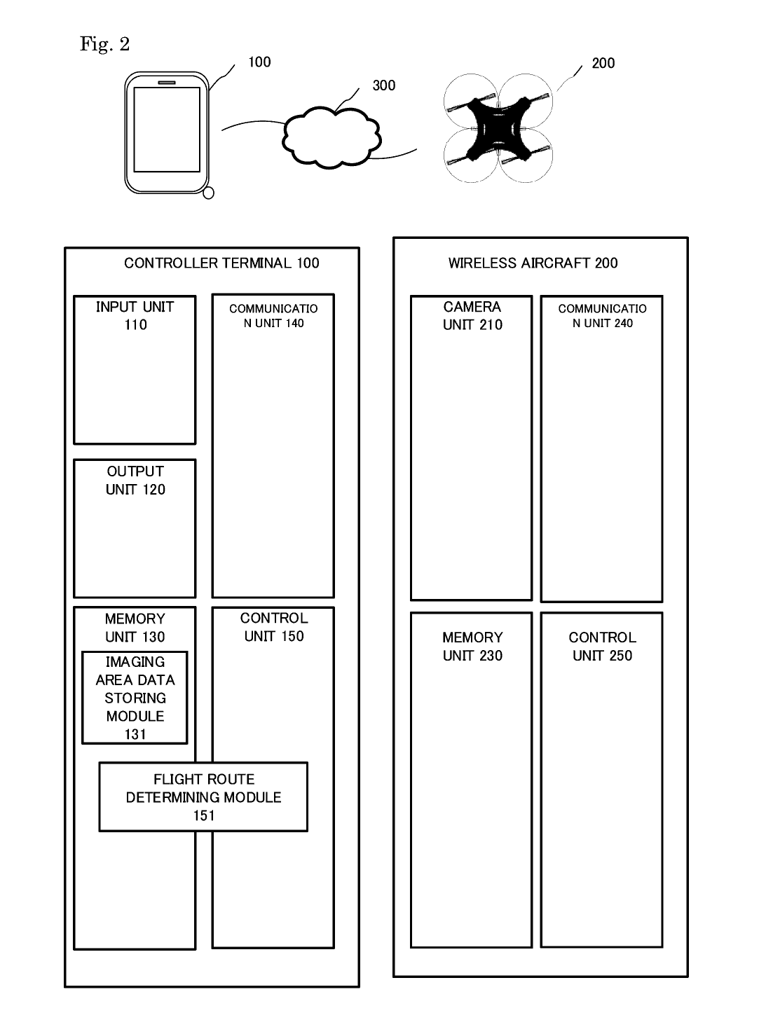

The controller terminal 100 includes an input unit 110, an output unit 120, a memory unit 130, a communication unit 140, and a control unit 150 as shown in FIG. 2. The memory unit 130 includes an imaging area data storing module 131. The control unit 150 achieves a flight route determining module 151 in cooperation with the memory unit 130. The wireless aircraft 200 has a capability of unmanned flight, which includes a camera unit 210, a memory unit 230, a communication unit 240, and a control unit 250. The controller terminal 100 can control the wireless aircraft 200 through wireless communication 300.

The controller terminal 100 may be a general information appliance such as a smart phone, a tablet PC, and a PC with a wireless communication function that are usable as a transmitter (proportional controller) for the wireless aircraft 200. The smart phone shown as the controller terminal 100 in attached drawings is just one example. The controller terminal 100 may also display a monitor and perform operation in cooperation with a specialized transmitter for the wireless aircraft 200 as shown in the upper part of FIG. 1. The controller terminal 100 may also install a global positioning system (hereinafter referred to as “GPS”) to acquire the latitude, the longitude, the altitude, etc., of the user who holds the controller terminal 100.

The wireless aircraft 200 includes a camera unit 210, which is capable of taking a still or a moving image. The wireless aircraft 200 may also install a GPS to acquire the latitude, the longitude, the altitude, etc., when taking an image.

The wireless communication 300 between the controller terminal 100 and the wireless aircraft 200 mainly uses the frequency band of 2.4 GHz which is the same as that Wi-Fi® and Bluetooth® or of 73 MHz for a radio controller in Japan. In the present invention, the communication between the controller terminal 100 and the wireless aircraft 200 only has to be feasible and is not limited by a frequency band, in particular.

The user may operate the controller terminal 100 to control the wireless aircraft 200 while checking the movement of the wireless aircraft 200 in visual range in the same way as a general radio controller or viewing a first-person view (hereinafter referred to as “FPV”) image transmitted from a camera on the user's monitor. In addition, the wireless aircraft 200 may be controlled by the user in real time or may be autonomously controlled by a program along the predetermined course.

First, the user specifies an imaging area by using the input unit 110 of the controller terminal 100 (step S101). At this time, the output unit 120 of the controller terminal 100 displays a map including the imaging area that the user desires to image. FIG. 4 shows one example of the screen of the controller terminal 100 displaying a map.

The imaging area may be specified by two diagonal points of a rectangular, etc., on the map as shown in FIG. 1 or by a circle or an oval. Alternatively, the imaging area may be any closed area specified freehand.

The imaging area data storing module 131 of the memory unit 130 of the controller terminal 100 stores the area that the user desires to image, as imaging area data (step S102). The imaging area data is stored to determine the flight route to take an image with the camera afterwards based on the imaging area specified on the map. Therefore, the data format of the imaging area data does not matter in particular. The latitude and the longitude of the corners of a rectangle may be stored, or the latitude and the longitude of the center or the radius of a circle may be stored. Moreover, a section on the map may be segmented into cells, a specified area of which may be stored.

Finally, the flight route determining module 151 of the controller terminal 100 determines the flight route and the altitude of the wireless aircraft 200 (step S103). The flight route and the altitude may be output to the output unit 120 of the controller terminal 100.

### Functions

FIG. 2 shows a functional block diagram of the controller terminal 100 and the wireless aircraft 200 to illustrate the relationship among the functions. The controller terminal 100 can control the wireless aircraft 200 through wireless communication 300.

The controller terminal 100 includes an input unit 110, an output unit 120, a memory unit 130, a communication unit 140, and a control unit 150. The memory unit 130 includes an imaging area data storing module 131. The control unit 150 achieves a flight route determining module 151 in cooperation with the memory unit 130.

The controller terminal 100 may a general information appliance such as a smart phone, a tablet PC, and a PC with a wireless communication function that are usable as a transmitter for the wireless aircraft 200. The smart phone shown as the controller terminal 100 in attached drawings is just one example. The controller terminal 100 may also display a monitor and perform operation in cooperation with a specialized transmitter for the wireless aircraft 200.

The user may operate the controller terminal 100 to control the wireless aircraft 200 while checking the movement of the wireless aircraft 200 in visual range in the same way as a general radio controller or viewing an FPV image transmitted from a camera on the user's monitor. In addition, the wireless aircraft 200 may be controlled by the user in real time or may be autonomously controlled by a program along the predetermined course.

The controller terminal 100 may also install a GPS to acquire the latitude, the longitude, the altitude, etc., of the user who holds the controller terminal 100.

The input unit 110 has a function necessary to input the above-mentioned imaging area. The input unit 110 may include a liquid crystal display to achieve a touch panel function, a key board, a mouse, a pen tablet, a hardware button on the device, and a microphone to perform voice recognition. The features of the present invention are not limited in particular by an input method.

The input unit 110 may also have a GUI and a voice input function to control the wireless aircraft 200.

The output unit 120 has functions necessary to output the flight route and the altitude of the wireless aircraft 200 that has been determined based on the imaging area data. The output unit 120 may take various forms such as a liquid crystal display, a PC display, and a speaker outputting voice. The features of the present invention are not limited in particular by an output method.

The output unit 120 may also have a display function to control the wireless aircraft 200 in FPV.

The memory unit 130 includes a data storage unit such as a hard disk or a semiconductor memory. The memory unit 130 includes an imaging area data storing module 131 to store the imaging area specified from the input unit 110. The memory unit 130 can store additional necessary information such as temporary data necessary to determine the flight route and the performance data of the wireless aircraft 200.

The communication unit 140 controls the wireless aircraft 200 through wireless communication 300. The wireless communication 300 between the controller terminal 100 and the wireless aircraft 200 mainly uses the frequency band of 2.4 GHz which is the same as that Wi-Fi® and Bluetooth® or of 73 MHz for a radio controller in Japan. In the present invention, the communication between the controller terminal 100 and the wireless aircraft 200 only has to be feasible and is not limited by a frequency band, in particular.

The control unit 150 includes a central processing unit (hereinafter referred to as “CPU”), a random access memory (hereinafter referred to as “RAM”), and a read only memory (hereinafter referred to as “ROM”). The control unit 150 achieves a flight route determining module 151 in cooperation with the memory unit 130.

When the controller terminal 100 controls the control wireless aircraft 200, the control unit 150 provides an instruction to the wireless aircraft 200 through the communication unit 140. The control unit 150 can provide an instruction to the wireless aircraft 200 when the wireless aircraft 200 is not only controlled by the user in real time but also autonomously controlled by a program along a predetermined course.

The wireless aircraft 200 has a capability of unmanned flight, which includes a camera unit 210, a memory unit 230, a communication unit 240, and a control unit 250. The wireless aircraft 200 may also install a GPS to acquire the latitude, the longitude, the altitude, etc., when taking an image.

The camera unit 210 includes a camera. The image taken by this camera is converted into digital data and stored in the memory unit 230. The image data can be transmitted to the controller terminal 100 through the communication unit 240 as required. The image may be a still or a moving image. If the image is a moving image, the control unit 250 can capture a part of the moving image to store in the memory unit 230 as a still image. The obtained taken image is an accurate image with information as much as the user needs. The pixel count and the image quality can be specified.

The memory unit 230 includes a data storage unit such as a hard disk or a semiconductor memory. The memory unit 230 can store necessary information such as temporary data necessary to autonomously control the wireless aircraft 200 by a program along a predetermined course in addition to an image data taken by the camera unit 210.

The communication unit 240 communicates with the controller terminal 100 through wireless communication 300. The communication unit 240 receives an instruction necessary for the flight and transmits image data, GPS data, etc. to the controller 100 as required.

The control unit 250 includes CPU, RAM, and ROM.

### Flight Route Determining Process

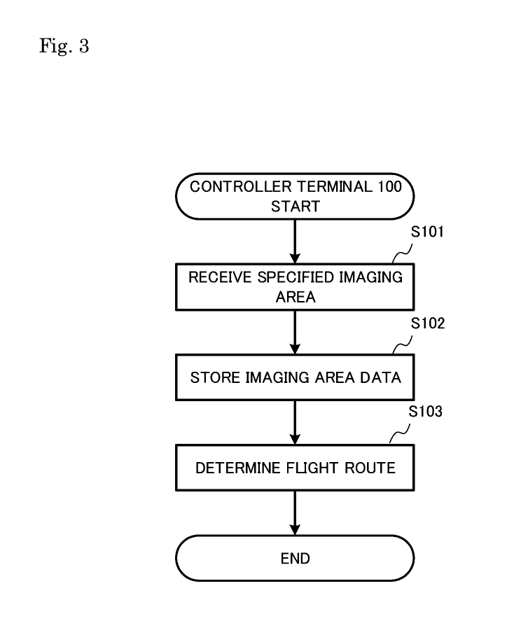

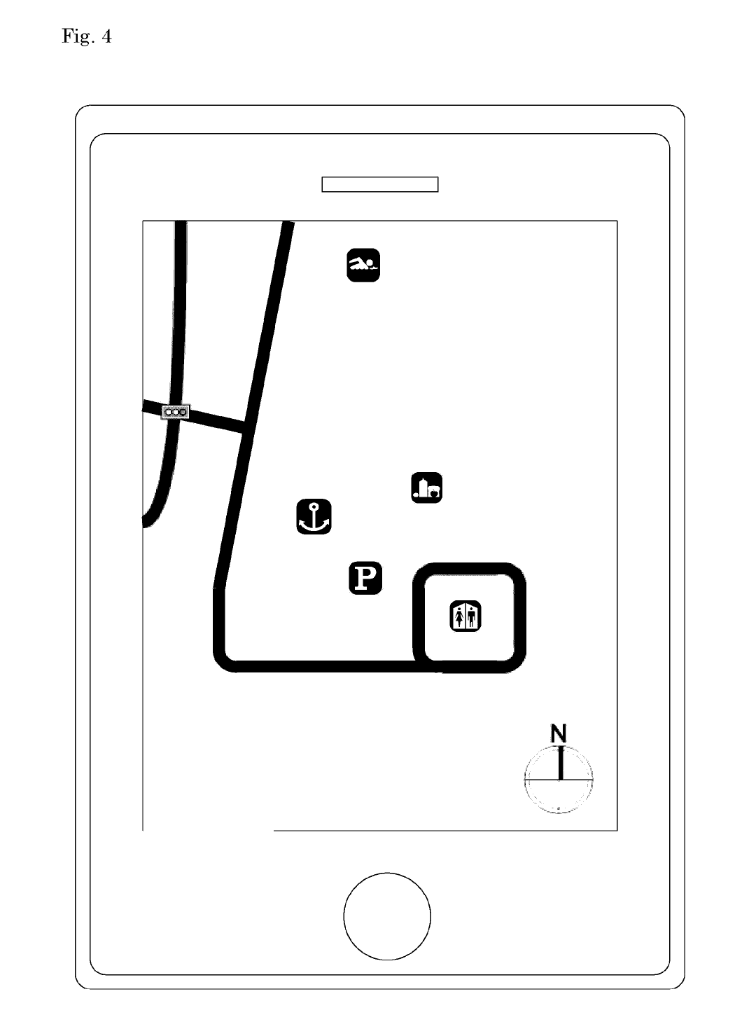

FIG. 3 shows a flow chart of the flight route determining process performed by the controller terminal 100. The processes performed by the units and the modules of the above-mentioned units are explained below together with this process.

First, the controller terminal 100 receives an imaging area specified from the input unit 110 (step S101).

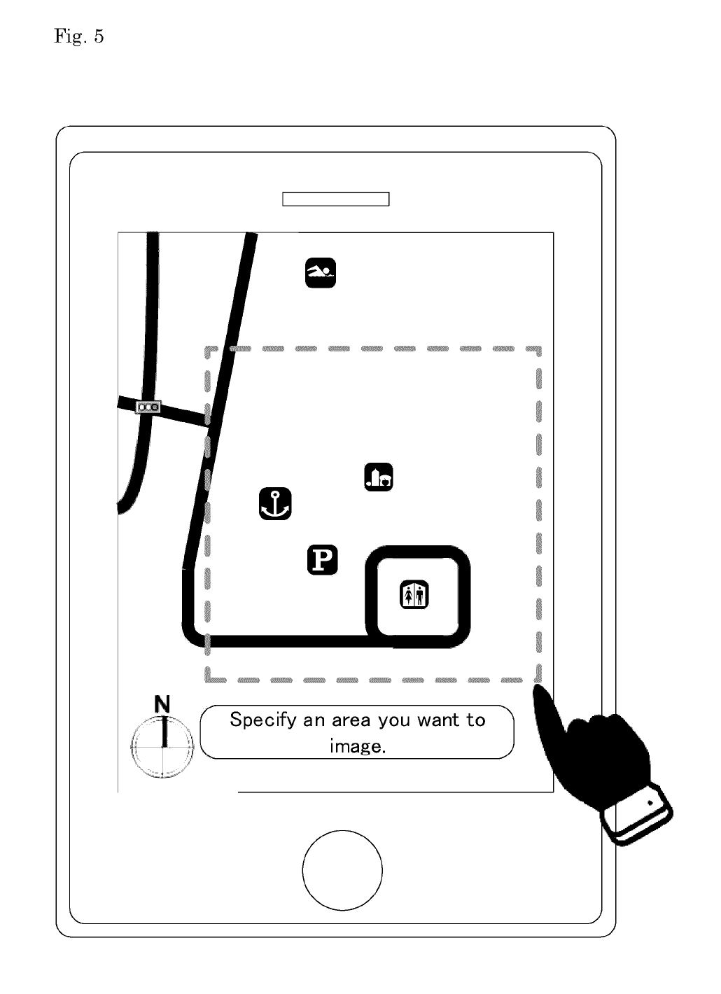

FIG. 5 shows one example of the screen from which the user specifies an imaging area.

In FIG. 5, the imaging area is a rectangle by specifying the upper left and the lower right of rectangle, etc., on the map. The imaging area may not be this form but a circle or an oval. Alternatively, the imaging area may be any closed area specified freehand. Furthermore, the imaging area may be specified by voice input.

Then, the imaging area data storing module 131 of the memory unit 130 of the controller terminal 100 stores the area input in the step S101 that the user desires to image, as imaging area data (step S102).

The imaging area data is stored to determine the flight route to take an image with the camera. Therefore, the data format of the imaging area data does not matter in particular. The latitude and the longitude of the corners of a rectangle may be stored, or the latitude and the longitude of the center or the radius of a circle may be stored. Moreover, a section on the map may be segmented into cells, a specified area of which may be stored.

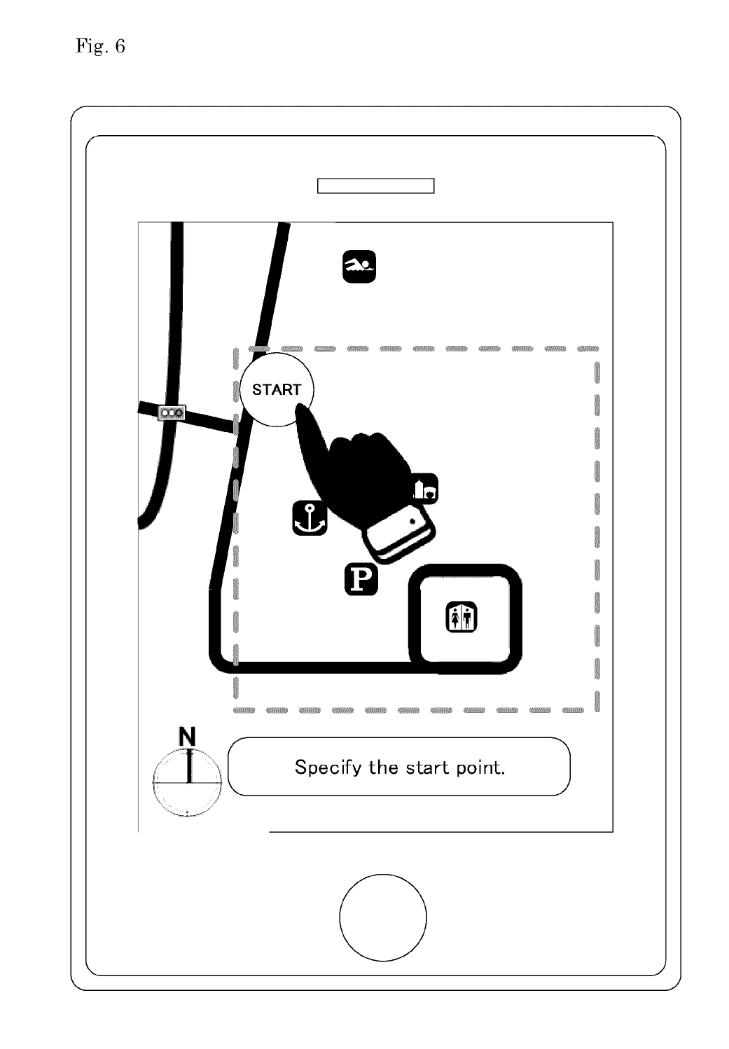

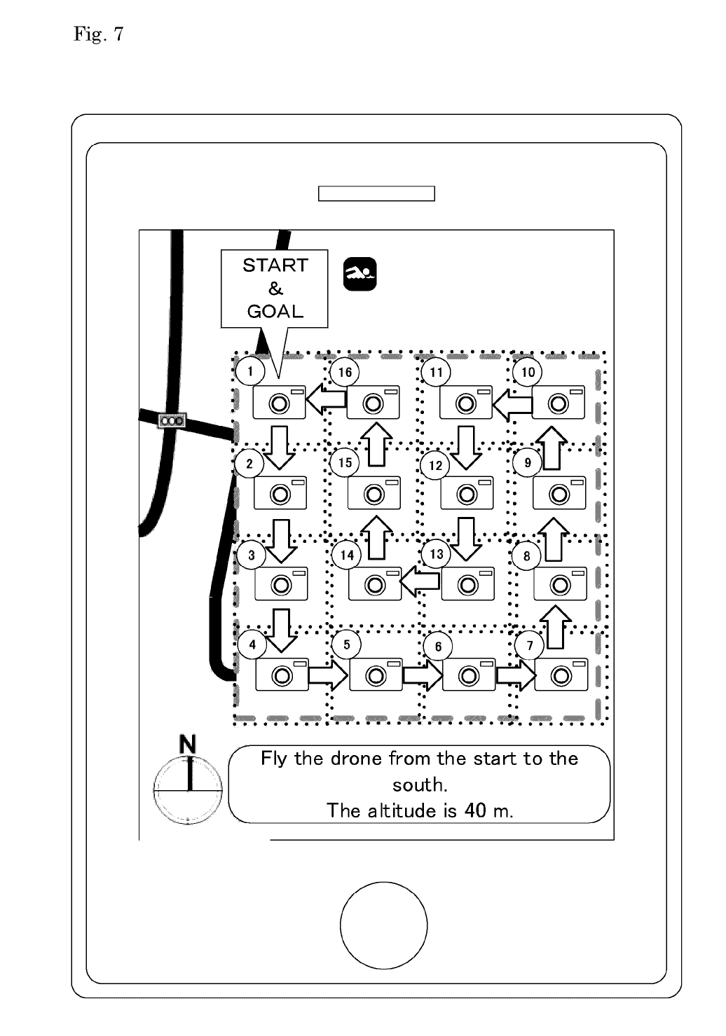

After receiving the specified imaging area, the start and the goal points of the flight route may be specified. FIG. 6 shows one example of the screen to specify the start point. FIG. 7 shows one example of the screen to specify the goal point. In FIGS. 6 and 7, the same points are specified for the start and the goal points. Making the start and the goal points the same can determine the flight route that the user does not have to move.

If the start and the goal points are not specified, the flight route with the shortest flight time may be determined. If the GPS function of the controller terminal 100 or the wireless aircraft 200 is available, the nearest place may be determined as the start point.

Finally, the flight route determining module 151 of the controller terminal 100 determines the flight route and the altitude of the wireless aircraft 200 (step S103). The flight route and the altitude may be output to the output unit 120 of the controller terminal 100.

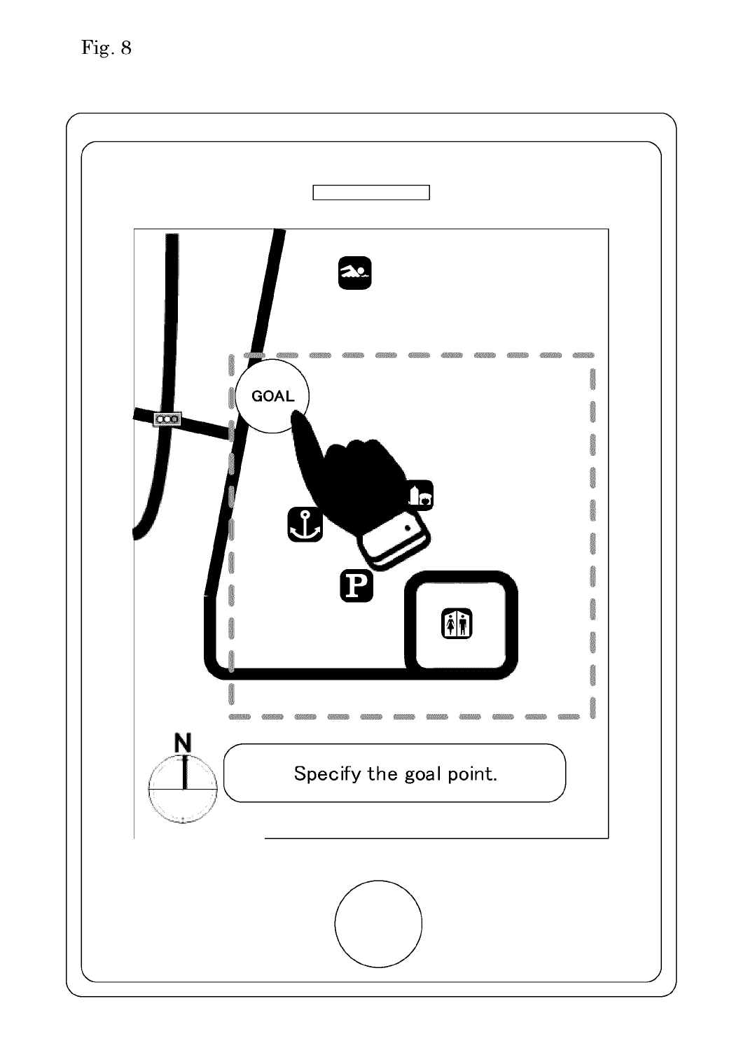

FIG. 8 shows one example of the screen outputting the flight route and the altitude. Specifically, FIG. 8 shows that the wireless aircraft 200 is to fly from the start point to the south at an altitude of 40 m, to take an image at the imaging points 1 to 16, and then to return to the goal point.

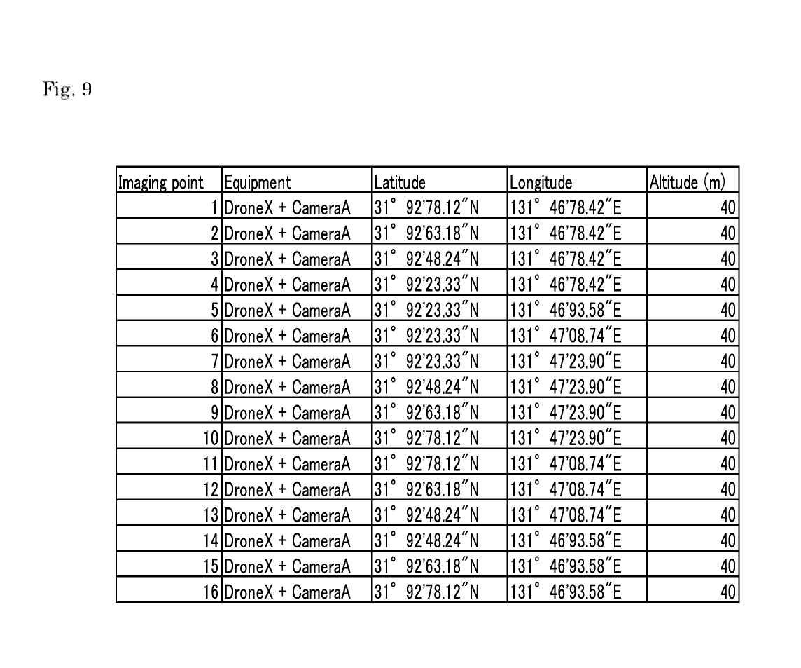

FIG. 9 shows one example of the data format of the flight route and the altitude that are determined by the flight route determining unit. Specifically, FIG. 9 shows how many latitudes, longitudes, and altitudes Drone X equipped with Camera A should take an image at the imaging points 1 to 16. In this embodiment, the latitude, the longitude, and the altitude are used. However, any data formats to show which point is located on the map according to the system may be used.

### Flight Route Determining Module

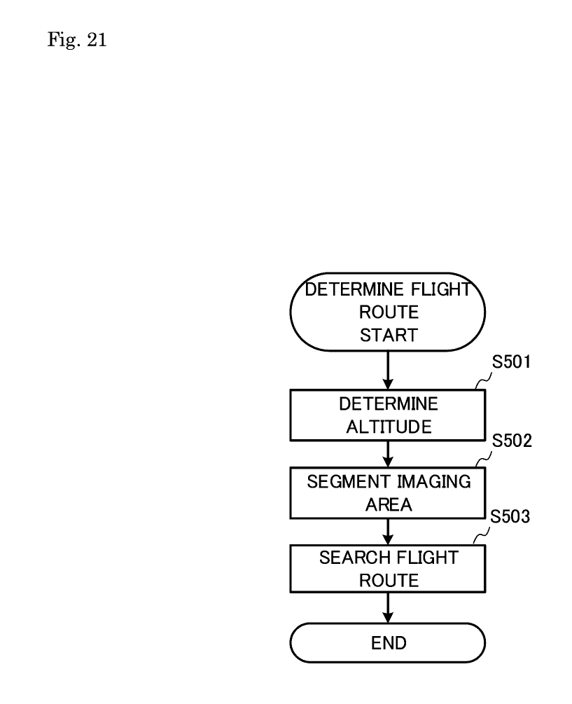

FIG. 21 shows a flow chart of the flight route determining module 151. The altitude and the flight route of the wireless aircraft 200 are determined by the flight route determining module 151.

First, the altitude is determined (step S501). The altitude is determined based on the image quality and the view that the user desires. How close to the object the wireless aircraft 200 should approach to obtain the image quality that the user desires or how much the wireless aircraft 200 should be lowered can be determined according to the performance of the camera unit 210 of the wireless aircraft 200. Therefore, the altitude suitable for the view that the user desires can be set to less than the determined altitude.

The altitude should be set by appropriately using the data such as map data in addition to the imaging area data in order not to fly into a tall structure in the imaging area.

In addition, since the limit altitudes under aviation law vary depending on the place, the altitude should be determined not to violate the aviation law.

To allow the user to select a desired image quality, the controller terminal 100 may display options of the resolution, etc., of an image desired to be finally obtained. If the altitude can be selected with a degree of range, the user may select an altitude, or the controller terminal 100 and the wireless aircraft 200 may automatically select a more suitable altitude. The controller terminal 100 may display a sample image, etc., for the user to select an altitude suitable for the view that the user desires.

If the limit altitude under aviation law and the highest altitude limited by a tall structure and the performance of the wireless aircraft 200 make the flight difficult in the imaging area that the user desires, the controller terminal 100 displays a notification to explain this situation.

Then, the imaging area is segmented (step S502). After the area where an image is taken in a single shot is found based on the altitude determined in the step S501, the specified imaging area is segmented.

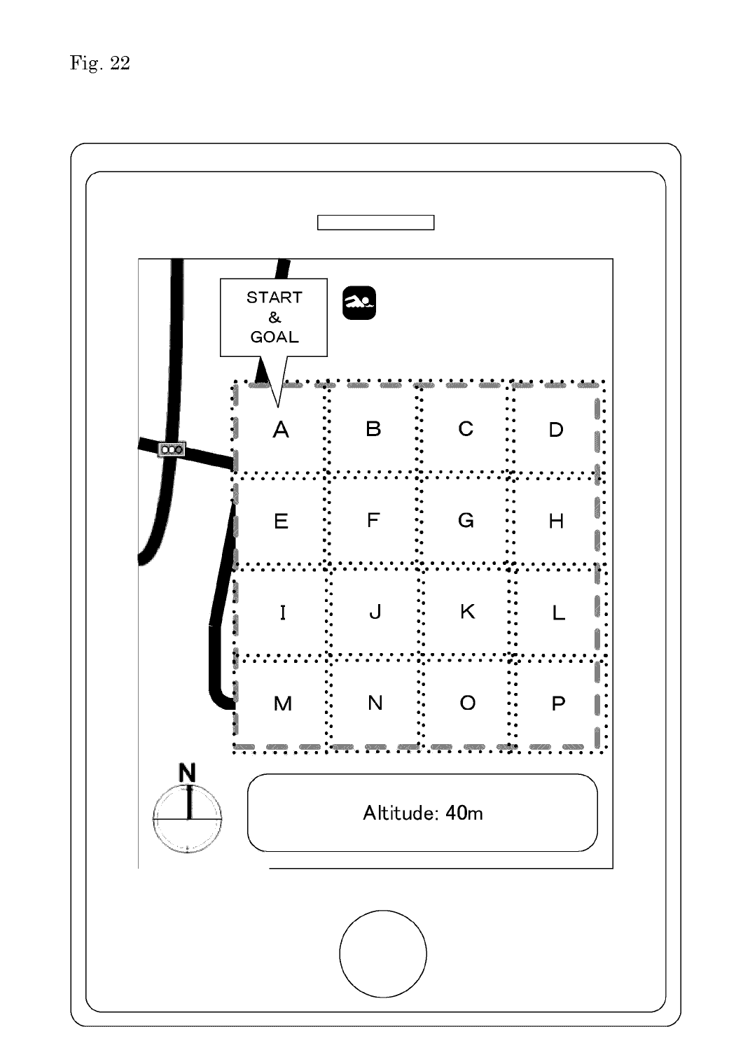

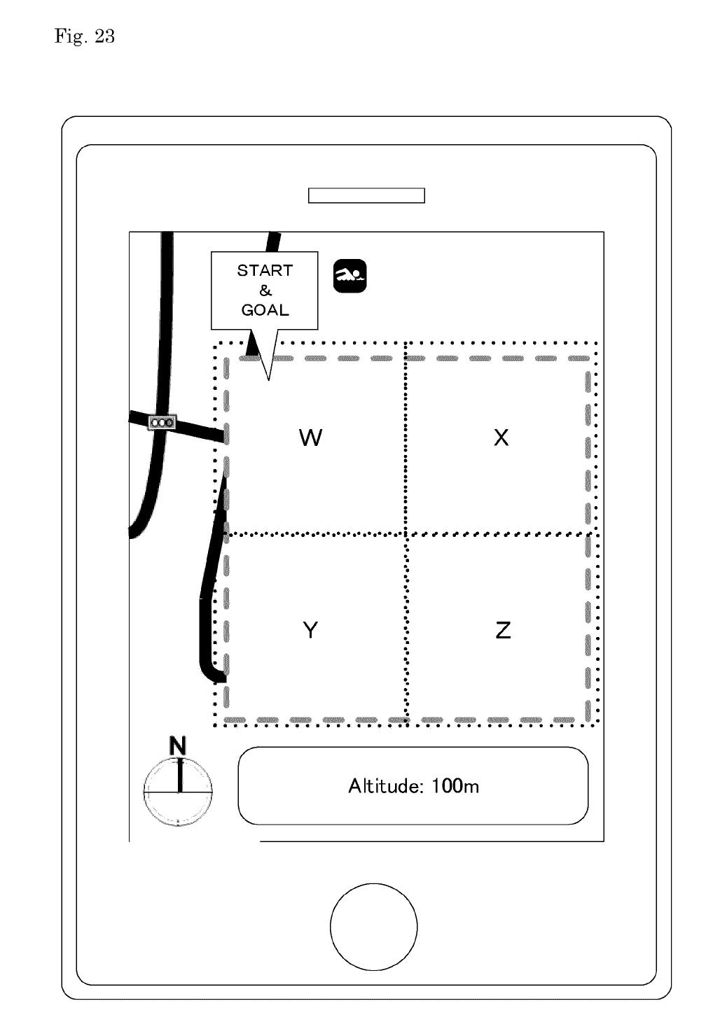

FIG. 22 shows one example of the segmented imaging area taken at an altitude of 40 m. The imaging area that the user has specified is segmented into sixteen the areas A to P, and an image is taken at these areas to obtain the image of the entire specified imaging area. FIG. 23 shows one example of the segmented imaging area taken at an altitude of 100 m. The imaging area that the user has specified is segmented into four the areas W to Z, and an image is taken at these areas to obtain the image of the entire specified imaging area.

Finally, the flight route is searched (step S503). The flight route to pass all the areas segmented in the step S502 can be searched by solving the route searching problem or the travelling salesman problem concerning the shortest route from the start point to the goal point. The algorithm for the flight route search does not limit the present invention. Any appropriate algorithms can be used according to the number of areas and the system of the controller terminal 100, etc.

If the determined flight route makes the wireless aircraft 200 difficult within the operating time due to its maximum operating time and flight speed, the controller terminal 100 may display a notification to explain this situation.

Functions when Image Data is Synthesized

If the area desired to be taken is large, an image may be hardly taken in a single shot due to the limitation of the maximum operating time and the flight speed, etc., of the wireless aircraft 200. In this case, a plurality of wireless aircrafts 200 should be used to take an image in a coordinated manner. If a plurality of wireless aircrafts 200 are used, the controller terminal 100 preferably synthesizes one image that the user desires to finally obtain from images taken by the wireless aircrafts 200.

The functions of the controller terminal 100 and the wireless aircraft 200 when image data is synthesized will be explained below. In this embodiment, the numbers of the controller terminals 100 and the wireless aircrafts 200 may be one, may be one and two or more, respectively, or may be two or more.

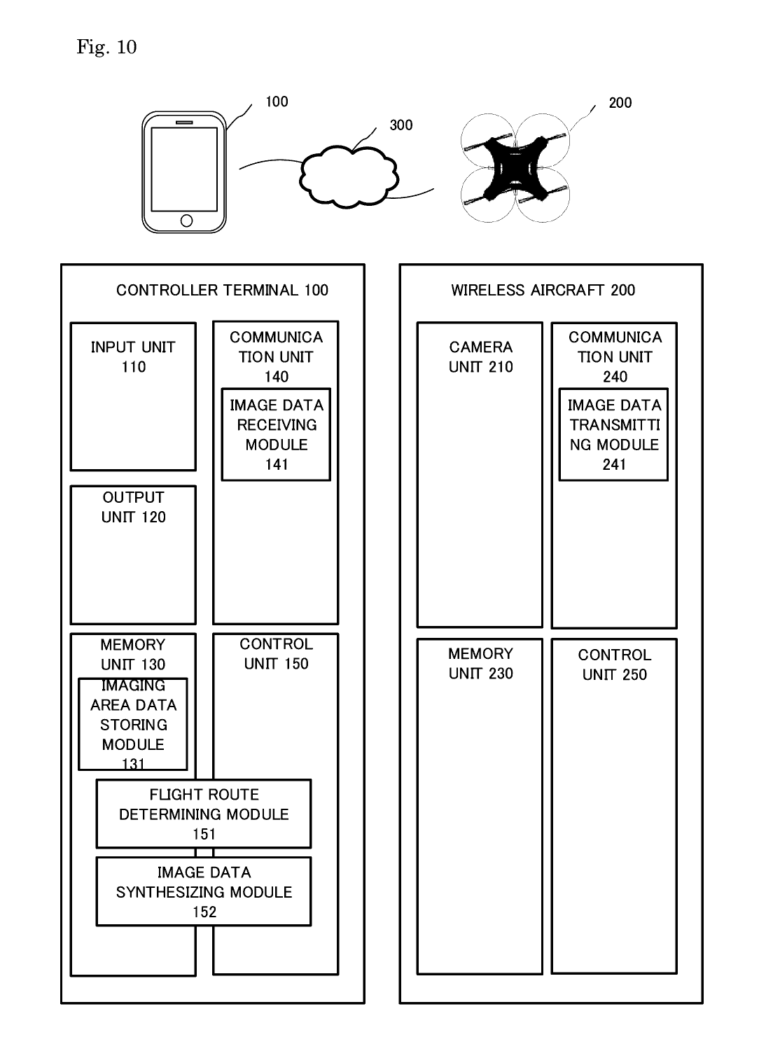

FIG. 10 shows a functional block diagram of the controller terminal 100 and the wireless aircraft 200 to illustrate the relationship among the functions when image data is synthesized. The controller terminal 100 can control the wireless aircraft 200 through wireless communication 300.

The controller terminal 100 includes an input unit 110, an output unit 120, a memory unit 130, a communication unit 140, and a control unit 150. The memory unit 130 includes an imaging area data storing module 131. The control unit 150 achieves a flight route determining module 151 and an image data synthesizing module 152 in cooperation with the memory unit 130. The communication unit 140 includes an image data receiving module 141.

The controller terminal 100 may be a general information appliance such as a smart phone, a tablet PC, and a PC with a wireless communication function that are useful as a transmitter for the wireless aircraft 200. The smart phone shown as the controller terminal 100 in attached drawings is just one example. The controller terminal 100 may also display a monitor and perform operation in cooperation with a specialized transmitter for the wireless aircraft 200.

The user may operate the controller terminal 100 to control the wireless aircraft 200 while checking the movement of the wireless aircraft 200 in visual range in the same way as a general radio controller or viewing an FPV image transmitted from a camera on the user's monitor. In addition, the wireless aircraft 200 may be controlled by the user in real time or may be autonomously controlled by a program along the predetermined course.

The controller terminal 100 may also install a GPS to acquire the latitude, the longitude, the altitude, etc., of the user who holds the controller terminal 100.

If the numbers of the controller terminals 100 and the wireless aircrafts 200 are one and two or more, respectively, the controller terminal 100 has a capability of controlling a plurality of wireless aircrafts 200. If the numbers of the controller terminals 100 and the wireless aircrafts 200 are two or more, the controller terminals 100 have a capability of specifying a controller terminal 100 to synthesize image data.

The input unit 110 has a function necessary to input the above-mentioned imaging area. The input unit 110 may include a liquid crystal display to achieve a touch panel function, a key board, a mouse, a pen tablet, a hardware button on the device, and a microphone to perform voice recognition. The features of the present invention are not limited in particular by an input method.

The input unit 110 may also have a GUI and a voice input function to control the wireless aircraft 200.

The output unit 120 has functions necessary to output the flight route and the altitude of the wireless aircraft 200 that has been determined based on the imaging area data. The output unit 120 may take various forms such as a liquid crystal display, a PC display, and a speaker outputting voice. The features of the present invention are not limited in particular by an output method.

The output unit 120 may also have a display function to control the wireless aircraft 200 in FPV.

If the numbers of the controller terminals 100 and the wireless aircrafts 200 are one and two or more, respectively, the input unit 110 may have a function to select which wireless aircraft 200 the controller terminal 100 controls.

The memory unit 130 includes a data storage unit such as a hard disk or a semiconductor memory. The memory unit 130 includes an imaging area data storing module 131 to store the imaging area specified from the input unit 110. The memory unit 130 can store additional necessary information such as temporary data necessary to determine the flight route and to synthesize image data and the performance data of the wireless aircraft 200.

The communication unit 140 controls the wireless aircraft 200. The communication unit 140 includes an image data receiving module 141 to receive the image data transmitted from the wireless aircraft 200.

The control unit 150 includes a CPU, a RAM, and a ROM. The control unit 150 achieves a flight route determining module 151 and an image data synthesizing module 152 in cooperation with the memory unit 130.

When the controller terminal 100 controls the control wireless aircraft 200, the control unit 150 provides an instruction to the wireless aircraft 200 through the communication unit 140. The control unit 150 can provide an instruction to the wireless aircraft 200 when the wireless aircraft 200 is not only controlled by the user in real time but also autonomously controlled by a program along a predetermined course. If the numbers of the controller terminals 100 and the wireless aircrafts 200 are one and two or more, respectively, the controller terminal 100 has a capability of controlling a plurality of wireless aircrafts 200.

The wireless aircraft 200 has a capability of unmanned flight, which includes a camera unit 210, a memory unit 230, a communication unit 240, and a control unit 250. The communication unit 240 includes an image data transmitting module 241. The wireless aircraft 200 may also install a GPS to acquire the latitude, the longitude, the altitude, etc., when taking an image.

The camera unit 210 includes a camera. The image taken by this camera is converted into digital data and stored in the memory unit 230. The image may be a still or a moving image. If the image is a moving image, the control unit 250 can capture a part of the moving image to store in the memory unit 230 as a still image. The obtained taken image is an accurate image with information as much as the user needs. The pixel count and the image quality can be specified.

The memory unit 230 includes a data storage unit such as a hard disk or a semiconductor memory. The memory unit 230 can store necessary information such as temporary data necessary to autonomously control the wireless aircraft 200 by a program along a predetermined course in addition to an image data taken by the camera unit 210.

The communication unit 240 communicates with the controller terminal 100 through wireless communication 300. The image data transmitting module 241 transmits image data to the controller terminal 100. The communication unit 240 also transmits GPS data, etc., necessary for other processing to the controller terminal 100.

The control unit 250 includes CPU, RAM, and ROM.

Flight Route Determining Process when Image Data is Synthesized

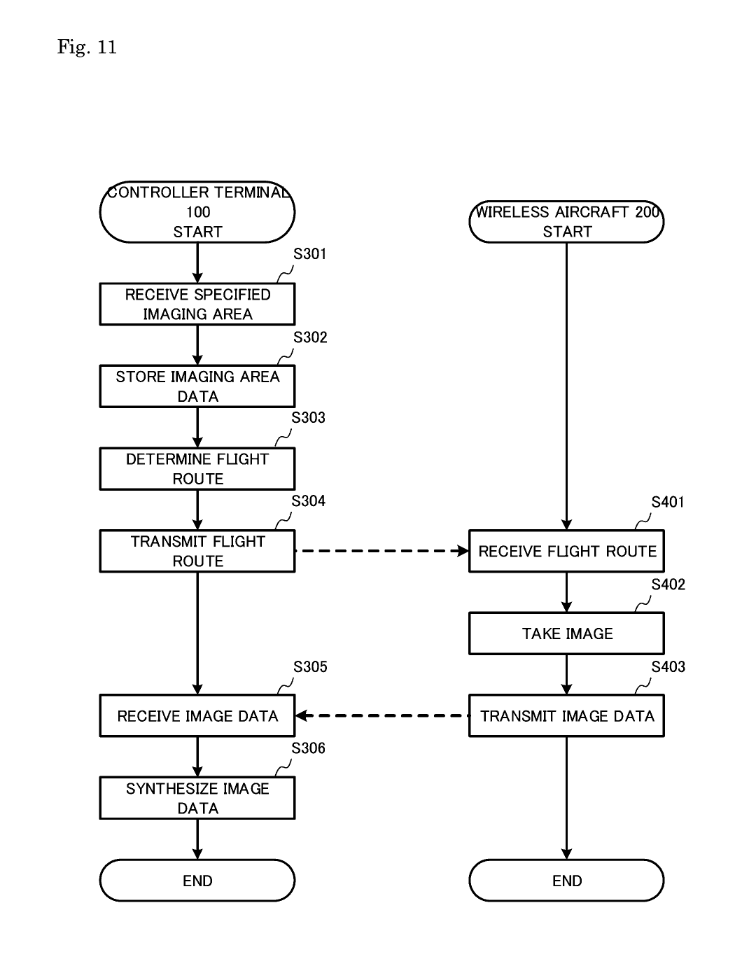

FIG. 11 shows a flow chart of the controller terminal 100 and the wireless aircraft 200 when image data is synthesized. The processes performed by the units and the modules of the above-mentioned units are explained below together with this process.

First, the controller terminal 100 receives an imaging area specified from the input unit 110 (step S301). The imaging area may be specified in the same way when image data is not synthesized, which is described above in reference to FIG. 5.

Then, the imaging area data storing module 131 of the memory unit 130 of the controller terminal 100 stores the area input in the step 5301 that the user desires to image, as imaging area data (step S302).

The imaging area data is stored to determine the flight route to take an image with the camera. Therefore, the data format of the imaging area data does not matter in particular. The latitude and the longitude of the corners of a rectangle may be stored, or the latitude and the longitude of the center or the radius of a circle may be stored. Moreover, a section on the map may be segmented into cells, a specified area of which may be stored.

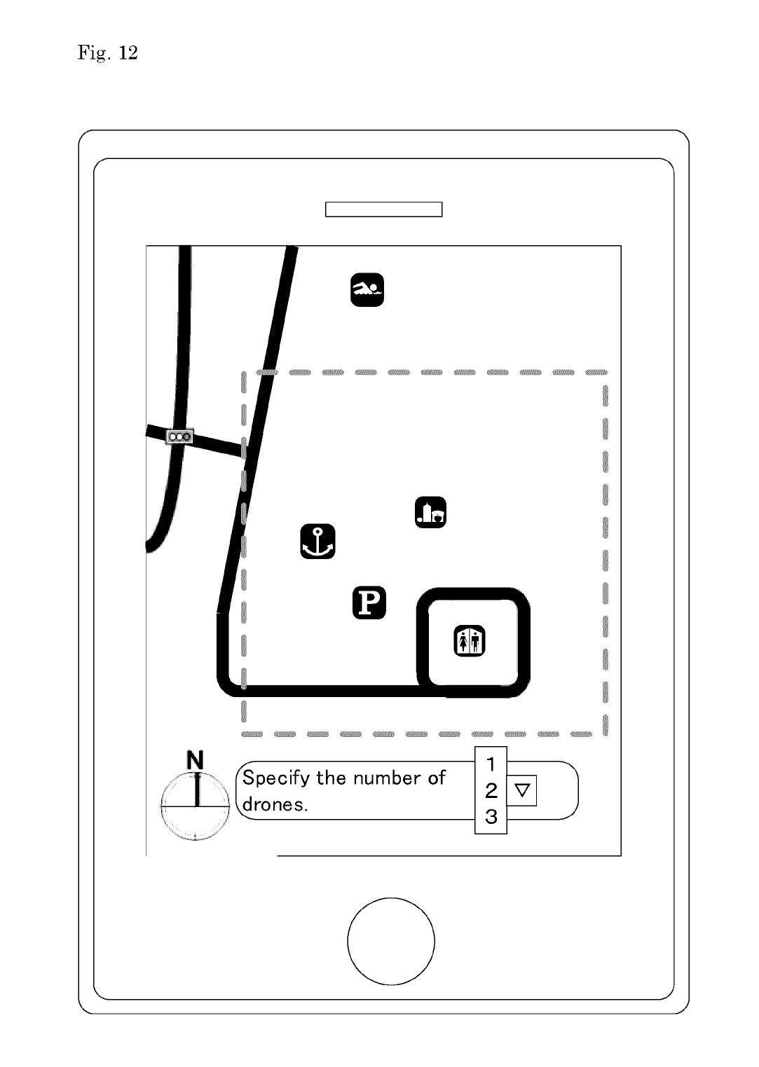

FIG. 12 shows one example of the screen to specify the number of the wireless aircrafts 200. The user can input how many wireless aircrafts 200 are used to take an image before determining the flight route.

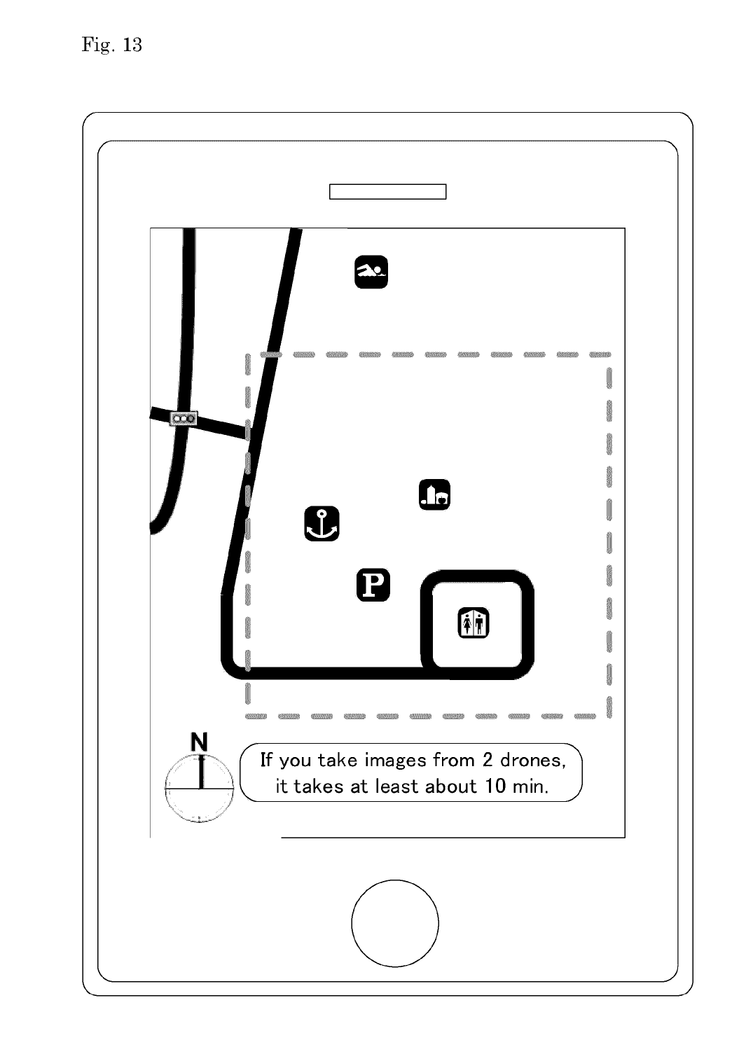

After the number of wireless aircrafts 200 is specified, the shortest required imaging time is displayed when the specified number of wireless aircrafts 200 are used. FIG. 13 shows one example of the screen displaying the estimated required time after the number of the wireless aircrafts 200 is specified. The display of the estimated time required for imaging based on the imaging area and the number of wireless aircrafts 200 enables the user to judge whether or not to take an image within the operating time of the wireless aircrafts 200 and also enables the user to appropriately change the number of wireless aircrafts 200 to be used.

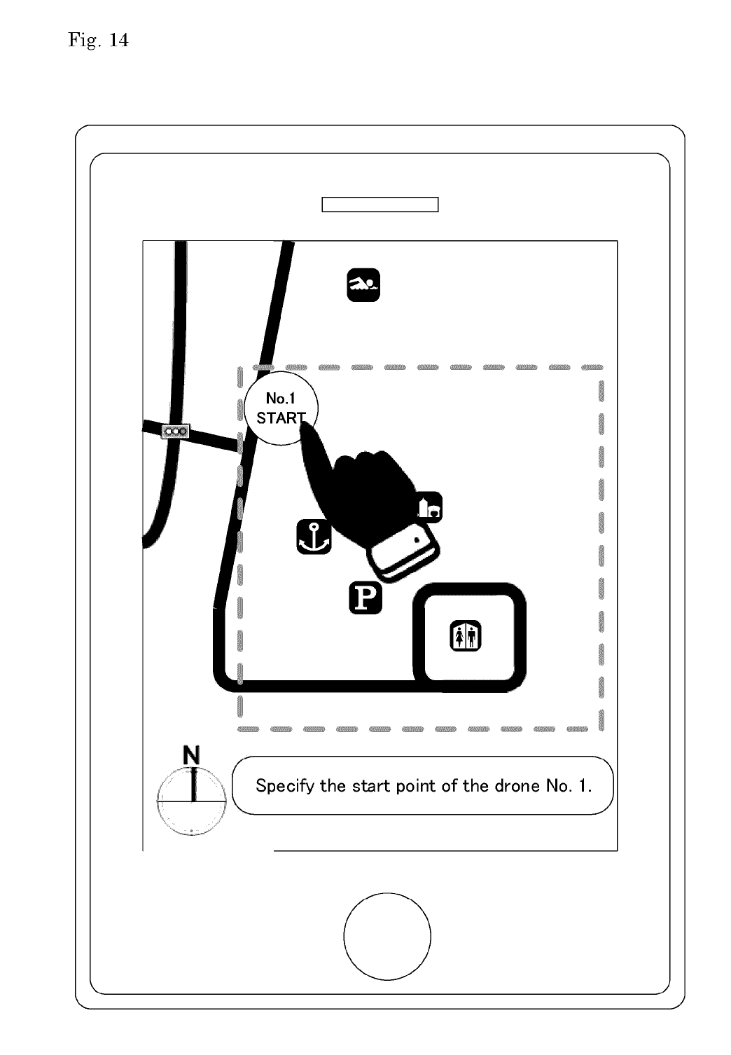

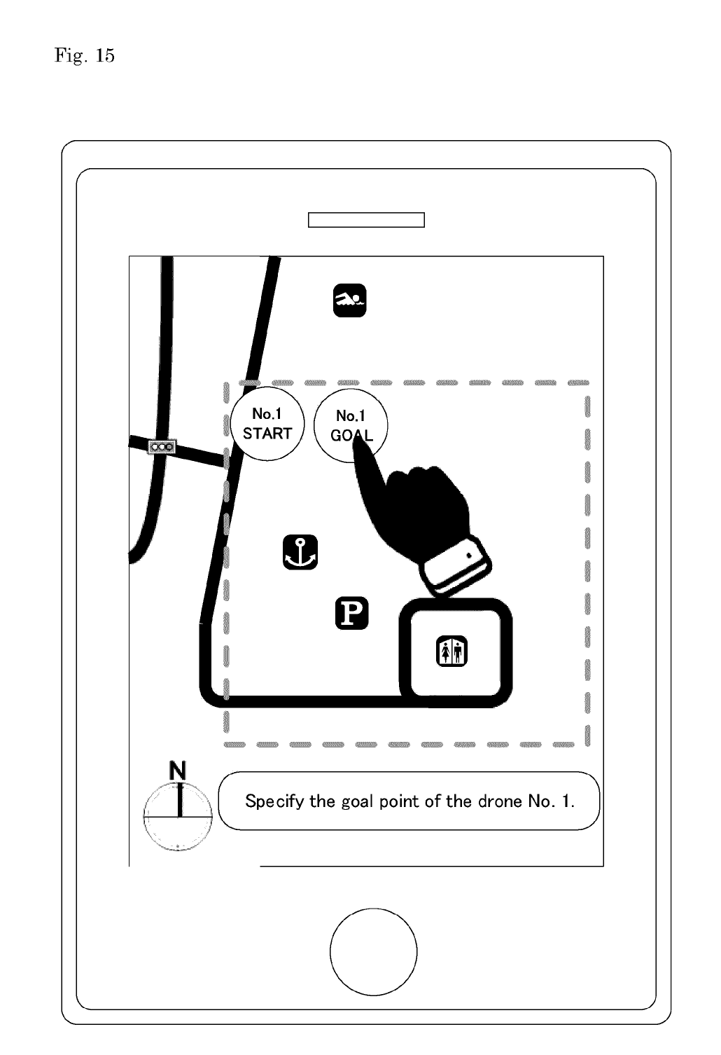

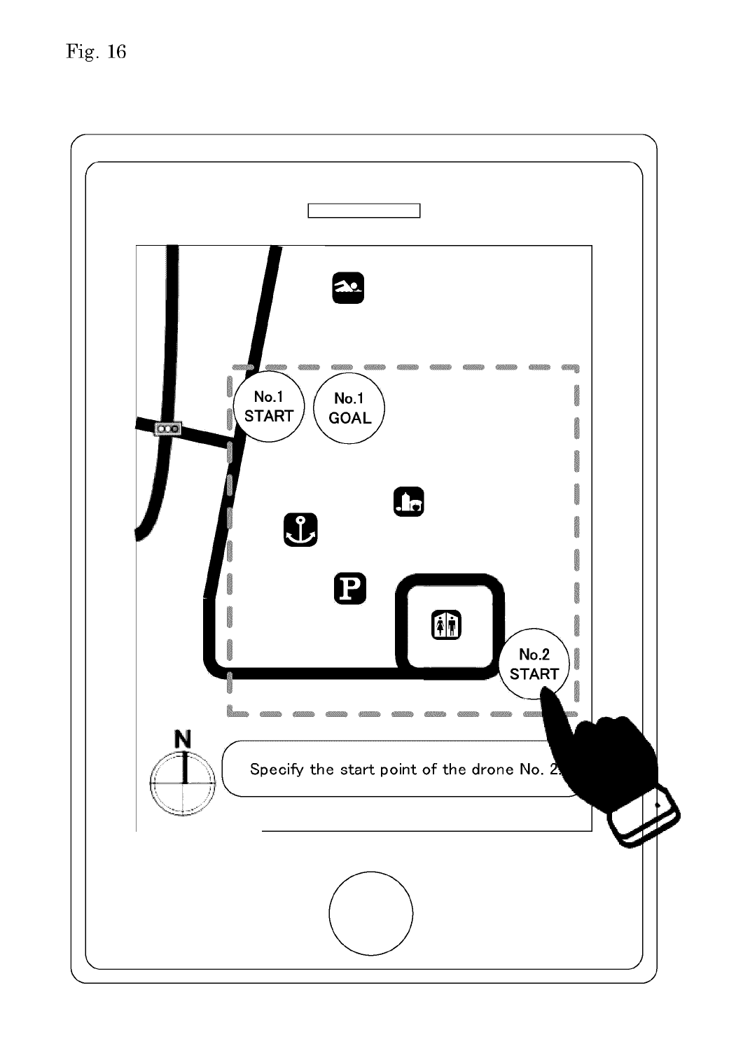

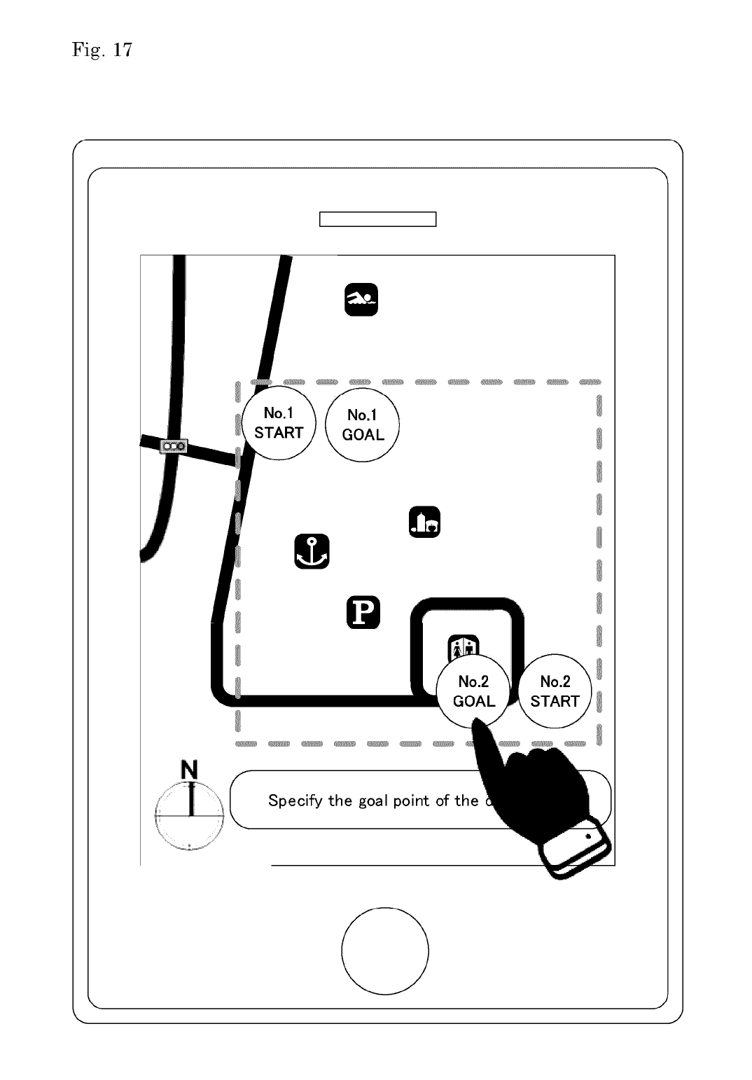

After receiving the specified imaging area and number of wireless aircrafts 200, the start and the goal points of the flight route may be specified. FIG. 14 shows one example of the screen to specify the start point of the first wireless aircraft 200. FIG. 15 shows one example of the screen to specify the goal point of the first wireless aircraft 200. FIG. 16 shows one example of the screen to specify the start point of the second wireless aircraft 200. FIG. 17 shows one example of the screen to specify the goal point of the second wireless aircraft 200.

If the start and the goal points are not specified, the flight route with the shortest flight time may be determined. If the GPS function of the controller terminal 100 or the wireless aircraft 200 is available, the nearest place may be determined as the start point.

Then, the flight route determining module 151 of the controller terminal 100 determines the flight route and the altitude of the wireless aircraft 200 (step S303). The flight route and the altitude may be output to the output unit 120 of the controller terminal 100. The processing by the flight route determining module 151 is described above in reference to FIG. 21.

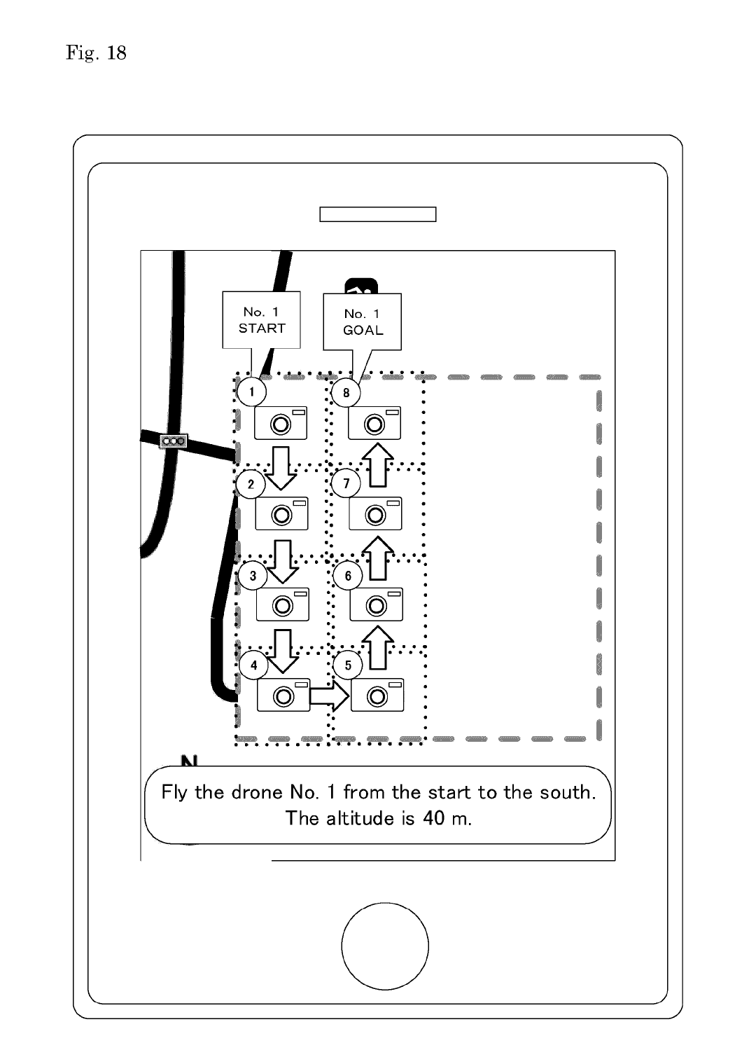

FIG. 18 shows one example of the screen outputting the flight route and the altitude of the first wireless aircraft 200. Specifically, FIG. 18 shows that the first wireless aircraft 200 is to fly from the start point to the south at an altitude of 40 m, to take an image at the imaging points 1 to 8, and then to return to the goal point.

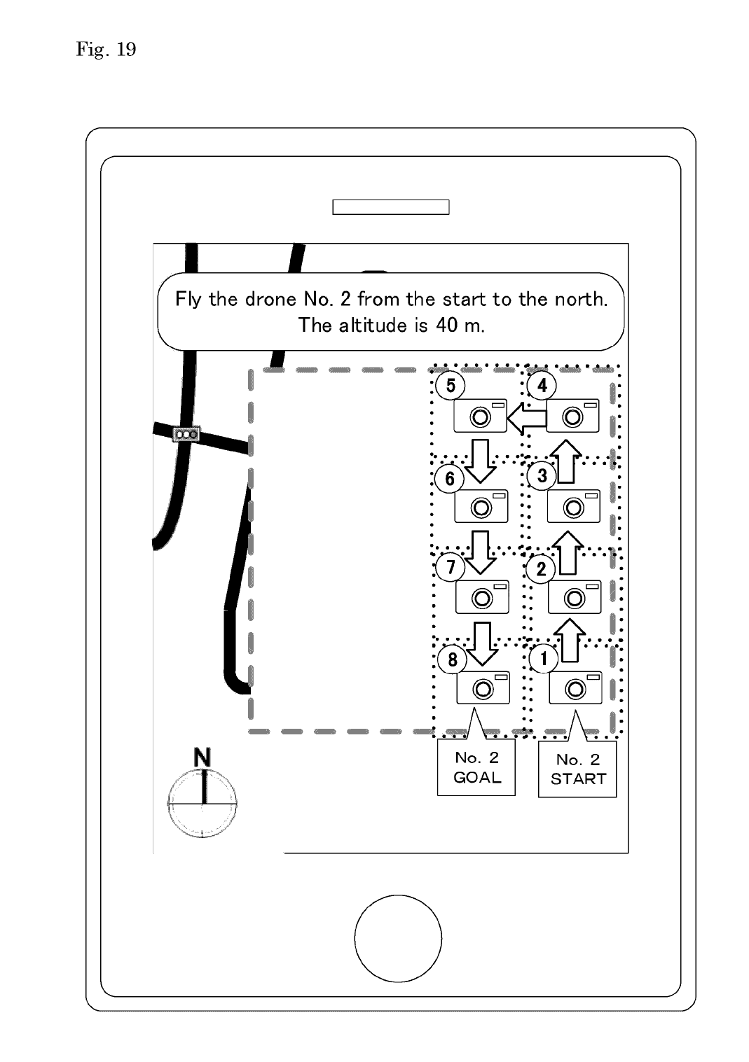

FIG. 19 shows one example of the screen outputting the flight route and the altitude of the second wireless aircraft 200. Specifically, FIG. 19 shows that the second wireless aircraft 200 is to fly from the start point to the north at an altitude of 40 m, to take an image at the imaging points 1 to 8, and then to return to the goal point.

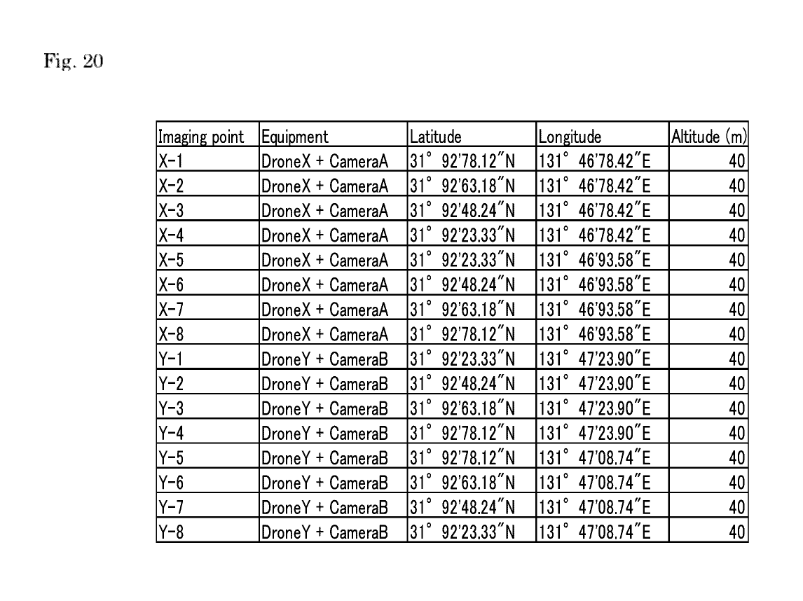

FIG. 20 shows one example of the data format of the flight route and the altitude of a plurality of wireless aircrafts 200 that are determined by the flight route determining unit. Specifically, FIG. 20 shows how many latitudes, longitudes, and altitudes Drone X equipped with Camera A should take an image at the imaging points X-1 to X-8. FIG. 20 also specifically shows how many latitudes, longitudes, and altitudes Drone Y equipped with Camera B should take an image at the imaging points Y-1 to Y-8. In this embodiment, the latitude, the longitude, and the altitude are used. However, any data formats to show which point is located on the map according to the system may be used.

Then, the flight route and the altitude that are determined in the step S303 are transmitted to the wireless aircraft 200 (step S304). The respective flight routes and altitudes are transmitted if two or more wireless aircraft 200 exist.

The wireless aircraft 200 receives the flight route and the altitude transmitted from the controller terminal 100 (step S401).

The wireless aircraft 200 takes an image based on the flight route and the altitude that are received in the step S401 (step S402). The flight of and the imaging from the wireless aircraft 200 may be controlled by the user in real time or may autonomously control by a program based on the received flight route and altitude.

If GPS is available in the wireless aircraft 200, GPS data is associated and stored with the image data. If GPS is unavailable, the image data is stored to identify the imaged time and the imaged order.

Then, the wireless aircraft 200 transmits the image data to the controller terminal 100 by using the image data transmitting module 241 (step S403). The image data may be transmitted at any time while the wireless aircraft 200 is flying or may be correctively transmitted after all the images are taken. If the numbers of the controller terminals 100 and the wireless aircrafts 200 are two or more, the image data of all the wireless aircrafts 200 is transmitted to the controller terminal 100 specified to synthesize image data. If existing, GPS data is transmitted together with image data. If GPS data do not exist, useful data for synthesizing image data, such as the imaged time and the imaged order, are also transmitted.

The controller terminal 100 receives image data taken from the wireless aircraft 200 by using the image data receiving module 141 (step S305). The controller terminal 100 also receives GPS data and other data for synthesizing image data, such as the imaged time and the imaged order. If the numbers of the controller terminals 100 and the wireless aircrafts 200 are two or more, the controller terminal 100 specified to synthesize image data collectively receives data.

Finally, the image data synthesizing module 152 of the controller terminal 100 synthesizes an image from the received image data (step S306). The image data synthesizing module 152 synthesizes an image by using GPS data and other data such as the imaged time and the imaged order. The use of the latitude and the longitude of the GPS data, the imaging route, the imaged time, and the imaged order enables a plurality of images to be appropriately arranged. The method of positioning the joints of a plurality of arranged images does not limit the present invention. Any conventional technologies suitable for the system of the controller terminal 100 can be used.

The embodiments of the present invention are described above. However, the present invention is not limited to the above-mentioned embodiments. The effect described in the embodiments of the present invention is only the most preferable effect produced from the present invention. The effects of the present invention are not limited to that described in the embodiments of the present invention.

### REFERENCE SIGNS LIST

100 Controller terminal
200 Wireless aircraft
300 Wireless communication

What is claimed is:

1. A controller terminal communicating with a wireless aircraft taking an image with a camera, comprising:
an imaging area data storing unit that stores imaging area data on an imaging area specified from a user; and
a flight route determining unit that determines the flight route and the altitude of the wireless aircraft to image the imaging area with a camera based on the stored imaging area data.

2. The controller terminal according claim 1, wherein the flight route determining unit that, if the imaging area based on the imaging area data is taken with a plurality of wireless aircrafts, determines the altitude and the flight route of each wireless aircraft.

3. The controller terminal according to claim 2 further comprising an image data receiving unit that receives image data taken by the flight route from the wireless aircraft, wherein the image data receiving unit, if receiving image data on a still image taken from a plurality of wireless aircrafts, superimposes the received image data on a predetermined image data based on the longitude and the latitude associated with the received image data.

4. A method executed by a controller terminal communicating with a wireless aircraft taking an image with a camera, comprising the steps of:
storing imaging area data on an imaging area specified from a user; and
determining the flight route and the altitude of the wireless aircraft to image the imaging area with a camera based on the stored imaging area data.
